(19) United States
(12) Patent Application Publication
(10) Pub. No.: US 2004/0174558 A1
(43) Pub. Date: Sep. 9, 2004

(54) Data transmitting and receiving device, facsimile machine, and data transmitting and receiving program

(75) Inventor: Hiromi Mori, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/792,788

(22) Filed: Mar. 5, 2004

(30) Foreign Application Priority Data
Mar. 7, 2003 (JP) 2003-062400

(51) Int. Cl. G06F 15/00; H04N 1/32; H04M 11/00

(52) U.S. Cl. 358/1.15; 358/468; 358/442; 379/100.12

(57) ABSTRACT

When a request of receipt of facsimile data has been received, it is determined whether a recording unit is in a printable state. When the recording unit is not in the printable state, it is determined whether a setting of transferring the facsimile data to a target storage server on the Internet has been made. When it is determined that the setting has been made, a facsimile machine receives the facsimile data and then converts the received facsimile data into file data. The converted facsimile data is attached to an e-mail and transmitted to the target storage server.

### BACKGROUND OF THE INVENTION

1. Field of Invention

The invention relates to a data transmitting and receiving device suitable for receiving facsimile data through a public switched telephone network, a facsimile machine equipped with the transmitting and receiving device, and a data transmitting and receiving program.

2. Description of Related Art

Japanese Laid-Open Patent Publication No. 2001-285539 (page 3) discloses a facsimile machine in which facsimile data received from an external device is temporarily stored in a received data memory provided in a RAM of the facsimile machine when the facsimile data cannot be printed by a printing device due to a printing failure caused by, for example, running out of paper or toner.

In the above facsimile machine, however, until the printing failure is resolved, received facsimile data is stored and accumulated in the received data memory one after another although the received data memory has a relatively small storage capacity. Therefore, the received data memory becomes full of received data in short order, whereby it often happens that the facsimile machine becomes unavailable to receive facsimile data.

### SUMMARY OF THE INVENTION

The invention provides a data transmitting and receiving device, that can receive facsimile data even when a data output unit has a problem, a facsimile machine equipped with the data transmitting and receiving device, and a data transmitting and receiving program.

According to one exemplary aspect of the invention, a data transmitting and receiving device includes a first communication device that performs data communication via a public switched telephone network, a second communication device that performs data communication via the Internet, a third communication device that performs data communication with a processing device that processes facsimile data, and a communication control device that determines whether the processing device connected to the third communication device can receive facsimile data when the first communication device receives the facsimile data via the public switched telephone network, wherein the communication control device transfers the facsimile data received by the first communication device to the processing device through the third communication device when the processing device can receive the facsimile data, and the communication control device transfers the facsimile data received by the first communication device to a predetermined server on the Internet through the second communication device when the processing device cannot receive the facsimile data.

According to the data transmitting and receiving device structured as described above, when the first communication device receives facsimile data via the public switched telephone network, the first communication device transfers the facsimile data to the processing device through the third communication device when the third communication device, connected to the processing device, can receive the facsimile data. When the processing device cannot receive the facsimile data, the data transmitting and receiving device stores the facsimile data, received by the first communication device, in the predetermined server on the Internet, through the second communication device.

Therefore, the first communication device can always receive the facsimile data via the public switched telephone line even when the processing device cannot receive the facsimile data.

### BRIEF DESCRIPTION OF THE DRAWINGS

Embodiments of the invention will be described in detail with reference to the following figures wherein:

FIG. 1 is a schematic, perspective view showing the appearance of a facsimile machine of embodiments of the invention;

FIG. 2 is a side, sectional view showing an internal structure of the facsimile machine of the embodiments;

FIG. 3 is a block diagram showing an electrical configuration of the facsimile machine of the first embodiment of the invention;

FIGS. 4A to 4D are explanatory diagrams showing data structures in a ROM and a RAM;

FIG. 5 is a flowchart of data transmitting and receiving processing performed in the first embodiment;

FIG. 6 is a flowchart of storage server setting processing performed in the first embodiment;

FIG. 7 is a flowchart of log displaying processing performed in the first embodiment;

FIG. 8 is an explanatory diagram of a structure of log control data of the first embodiment;

FIG. 9 is a block diagram showing an electrical configuration of a facsimile machine of the second embodiment;

FIG. 10 is a flowchart of data transmitting and receiving processing performed in the second embodiment; and

FIG. 11 is an explanatory diagram of a structure of log control data of the second embodiment.

### DETAILED DESCRIPTION OF PREFERRED EMBODIMENTS

Embodiments of the invention will be described with reference to the accompanying drawings. A first embodiment will now be described.

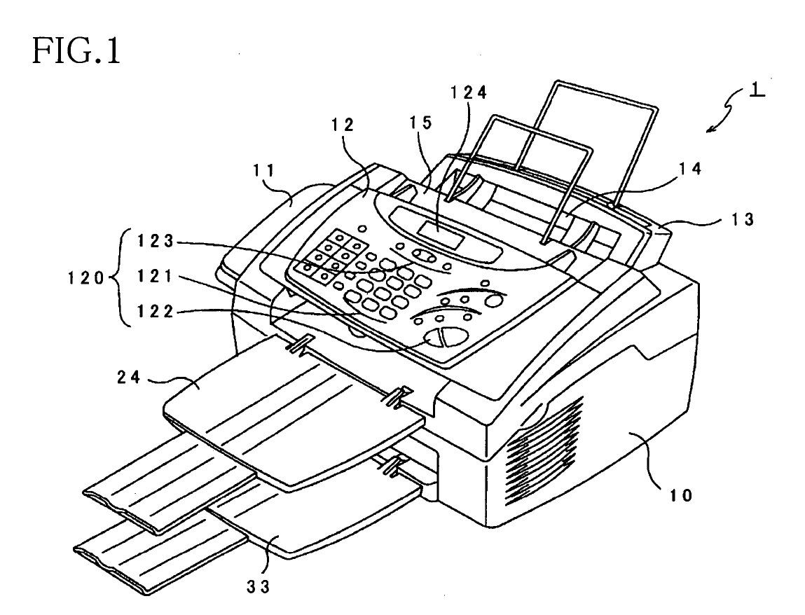

As shown in FIG. 1, a facsimile machine 1 includes a body case 10, a handset 11 provided on the side of the body case 10, and an operating panel 12 provided at an upper front surface of the body case 10. The operating panel 12 includes a plurality of operating keys 120, such as numeric keys 121 for inputting telephone numbers and/or facsimile numbers of receivers, a start key 122, and selecting keys 123, and a liquid crystal display (LCD) 124 for displaying information regarding various functions.

The facsimile machine 1 further includes a first sheet tray 13 and a second sheet tray 14. The first sheet tray 13 is provided at an upper rear portion of the body case 10 in order to accommodate recording sheets to be supplied into the facsimile machine 1. The second sheet tray 14 is provided above the first sheet tray 13 in order to accommodate recording sheets manually fed by a user. A document tray 15 is provided above the second sheet tray 14 to hold documents to be scanned.

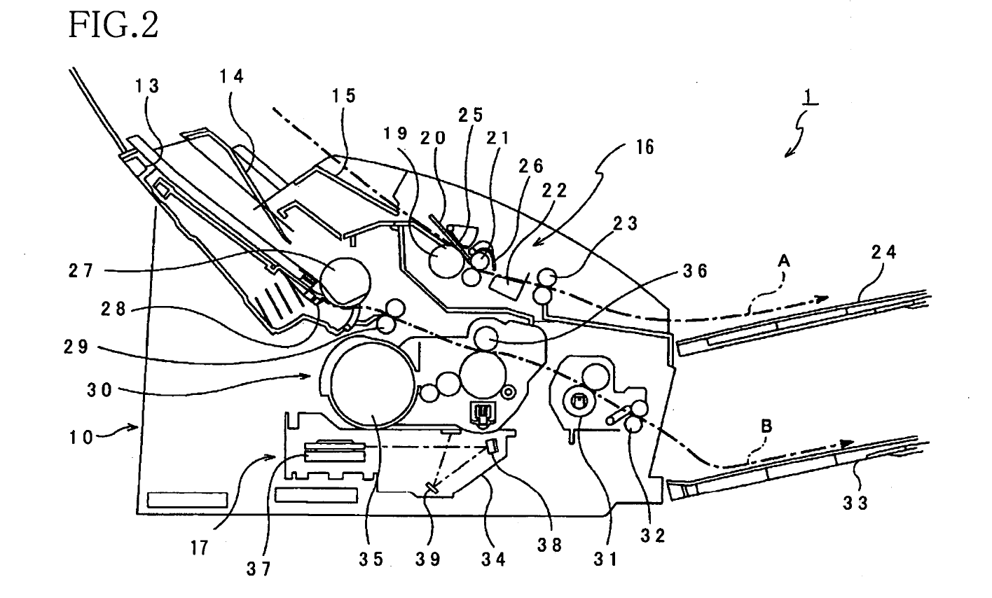

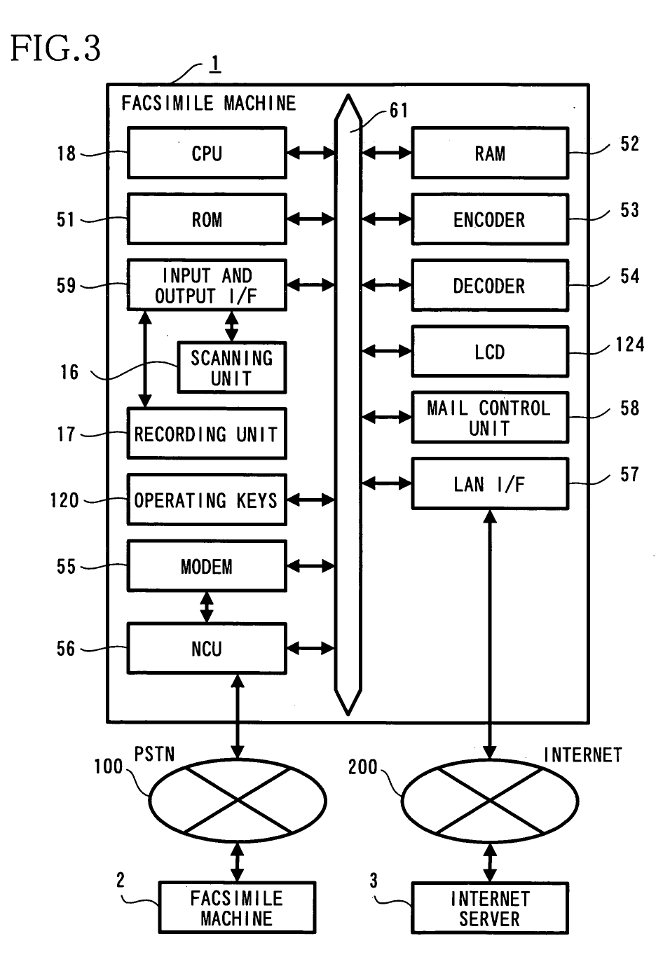

As shown in FIG. 2, a scanning unit 16 for reading an image from a document, a recording unit 17 for forming an image onto a recording sheet, and a substrate (not shown) equipped with a CPU 18 (FIG. 3) controlling driving of each unit are built into the facsimile machine 1.

In the scanning unit 16, first, documents placed on the document tray 15 are detected by a document sensor (not shown) and are fed into the inside of the facsimile machine 1, one by one, by a sheet feeding mechanism including a sheet feed roller 19 and a separation pad 20. Then, the document is conveyed to a scanner 22 by a pair of conveyor rollers 21 and the image formed on the document is scanned by the scanner 22. After scanning, the document is ejected onto a first output tray 24, provided at a front of the body case 10, via a pair of ejecting rollers 23. The path of the document in the scanning unit 16 is shown by an arrow A in FIG. 2.

The scanning unit 16 further includes a front document sensor 25 for detecting a leading edge of a document, and a rear document sensor 26 for detecting a trailing edge of the document. The CPU 18 controls a sheet feeding distance by controlling each portion of the scanning unit 16 in accordance with the detected results of the sensors 25, 26 and realizes operation of the scanning unit 16.

In the recording unit 17, recording sheets loaded on the first sheet tray 13 or the second sheet tray 14 are taken into the inside of the facsimile machine 1, one by one, by a sheet feeding mechanism that includes a sheet supply roller 27 and a separation pad 28. Then, the recording sheet is conveyed to an image forming unit 30 by a pair of conveyor rollers 29. In the image forming unit 30, an image is formed on the recording sheet using toner. Then, the recording sheet is conveyed to a fixing unit 31 to fix the toner image onto the recording sheet. The recording sheet is then ejected onto a second output tray 33 provided at the front of the body case 10, via a pair of ejecting rollers 32. The path of the recording sheet through the recording unit 17 and the fixing unit 31 is shown by an arrow B in FIG. 2.

In the image forming unit 30, a laser beam is irradiated onto a photoconductive drum by driving a laser beam scanning unit 34 to form an electrostatic latent image on the surface of the photoconductive drum. The laser beam scanning unit 34 includes a laser beam emitting portion 37 that emits a laser beam based on image data in accordance with instructions issued by the CPU 18, a lens 38 that reflects the laser beam emitted from the laser beam emitting portion 37, and a reflecting mirror 39 that redirects the laser beam, reflected from the lens 38, to the photoconductive drum. The image forming unit 30 further includes a toner tank 35 holding toner particles that are adhered on the surface of the photoconductive drum having the electrostatic latent image. The toner image formed on the photoconductive drum is then transferred onto the recording sheet by a transfer roller 36 by applying an electrical charge. FIG. 2 is a schematic diagram for explaining the function of the image forming unit 30. The image forming unit 30 of the embodiment has the same structure as a well-known image forming unit that can form an toner image.

Next, an electrical configuration of the facsimile machine 1 will be described. The facsimile machine 1 includes the CPU 18, a ROM 51, a RAM 52, the scanning unit 16, an encoder 53, the recording unit 17, a decoder 54, the operating keys 120, the LCD 124, a modem 55, a network control unit (NCU) 56, a LAN interface (LAN I/F) 57, a mail control unit 58, and an input and output interface (input and output I/F) 59, which are connected with each other via a bus 61.

The CPU 18 is a brain of the facsimile machine 1 and executes centralized control of the facsimile machine 1. For example, the CPU 18, reads a control program from the ROM 51 to execute a facsimile data transmitting/receiving operation and a receiver data registering operation in accordance with the control program.

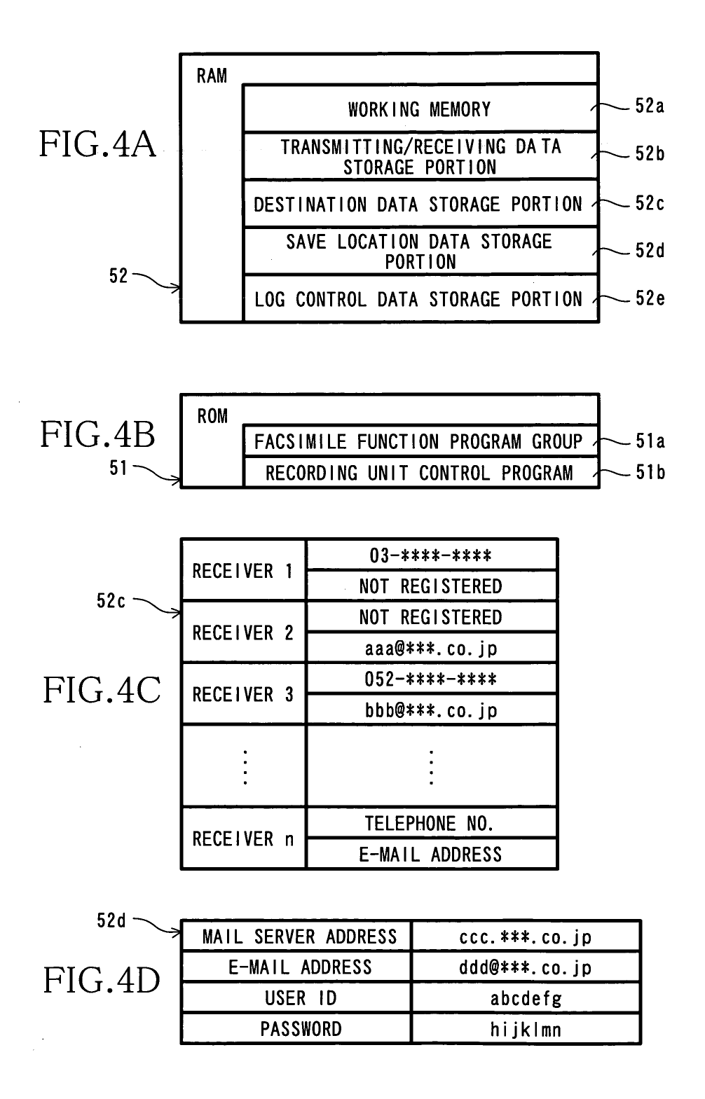

The ROM 51 stores a facsimile function program group 51a (FIG. 4B). More specifically, for example, the ROM 51 stores a data receiving program for forming an image by the recording unit 17 according to the facsimile data received by the network control unit 56 from an external facsimile machine 2, as the facsimile function program.

In addition, the ROM 51 prestores a recording unit control program 51b to be called up in the above program, various other programs and various data required during execution of the various programs.

The RAM 52 serves as a working memory 52a to be used when various controls are executed (FIG. 4A), a transmitting/receiving data storage portion 52b for storing facsimile data, a destination data storage portion 52c for storing destination data regarding receivers of facsimile data, a save location data storage portion 52d for storing a mail address of a storage server where facsimile data is to be saved, and a log control data storage portion 52e for storing log data regarding received facsimile data.

As shown in FIG. 4C, the destination data storage portion 52c can store telephone numbers and e-mail addresses regarding receivers of facsimile data, as destination data. That is, the facsimile machine 1 is designed so as to be able to register both a telephone number and an e-mail address with respect to one receiver as destination data, in the case of a device on the other end (the external facsimile machine 2 or an Internet server 3) that can perform a transmitting and receiving operation of facsimile data through at least one of a public switched telephone network (PSTN) 100 and transmitting and receiving operation of e-mail through the Internet 200.

As shown in FIG. 4D, the save location data storage portion 52d can store a mail server address and an e-mail address of the storage server for identifying a target storage server, and a user ID and a password to be used for logging on to the storage server.

The scanning unit 16 scans and reads a document in order to transmit facsimile data or to make a copy of the document. As described above, the scanning unit 16 obtains the document from the document tray 15, scans and reads an image by means of the scanner 22, and outputs image data to the encoder 53 as a scanned result. The encoder 53 performs an encoding operation to convert the image data read by the scanning unit 16 into encoded image data in G3 format (facsimile format) and then outputs the image data.

The decoder 54 decodes image data presented in the facsimile format by converting the data into image data processible in the recording unit 17.

The recording unit 17 functions as a so-called laser-beam printer that can form an image on a recording sheet, as described above. The recording unit 17 prints an image on a recording sheet according to image data decoded by the decoder 54, by using the image forming unit 30, and outputs the recording sheet having the image thereon after the printing operation is completed, in accordance with instructions provided from the CPU 18 that runs the recording unit control program 51b.

The operation keys 120 input a command signal into the CPU 18 to perform various operations, such as registration of destination data, assignment of destinations, and input and selection of notes data, in accordance with operations performed by a user.

The LCD 124, as a display unit, displays various messages that show operating procedures and to inform the user of errors. The LCD 124 also functions as a touch-sensitive panel in order to display one-touch keys thereon when input from the user is required (the assignment of a destination of facsimile data and registration of destination data). As described above, the LCD 124 inputs data into the facsimile machine 1 by obtaining data from the user's operations.

The modem 55 is provided so as to transmit and receive facsimile data to and from an external facsimile machine 2 connected to the PSTN 100, via the network control unit 56. The network control unit 56 sends a dial signal to the PSTN 100 and answers a ringing signal from the PSTN 100. For example, the network control unit 56 allows itself to communicate with the external facsimile machine 2.

The LAN interface 57 is connected to the Internet 200 so that the facsimile machine 1 can transmit and receive facsimile data to and from the Internet server 3 via the Internet 200.

The mail control unit 58 converts binary image data in a facsimile format, which is encoded by the encoder 53, into image data in a text code. In addition, by adding header data including, for example, an e-mail address of a receiver, to the image data, the mail control unit 58 converts the image data in the facsimile format into image data in an electronic mail format transmittable as an e-mail (a normal format conversion) and converts image data in the electronic mail format received via the LAN interface 57 through the Internet 200 into image data in the facsimile format (a reverse format conversion).

The image data whose format was changed to the facsimile format by the mail control unit 58 is decoded to image data by the decoder 54 and then printed onto a recording sheet. The input and output interface 59 is connected with the scanning unit 16 and the recording unit 17. Image data is inputted into the encoder 53 from the scanning unit 16 via the input and output interface 59, and is outputted from the decoder 54 to the recording unit 17 via the input and output interface 59.

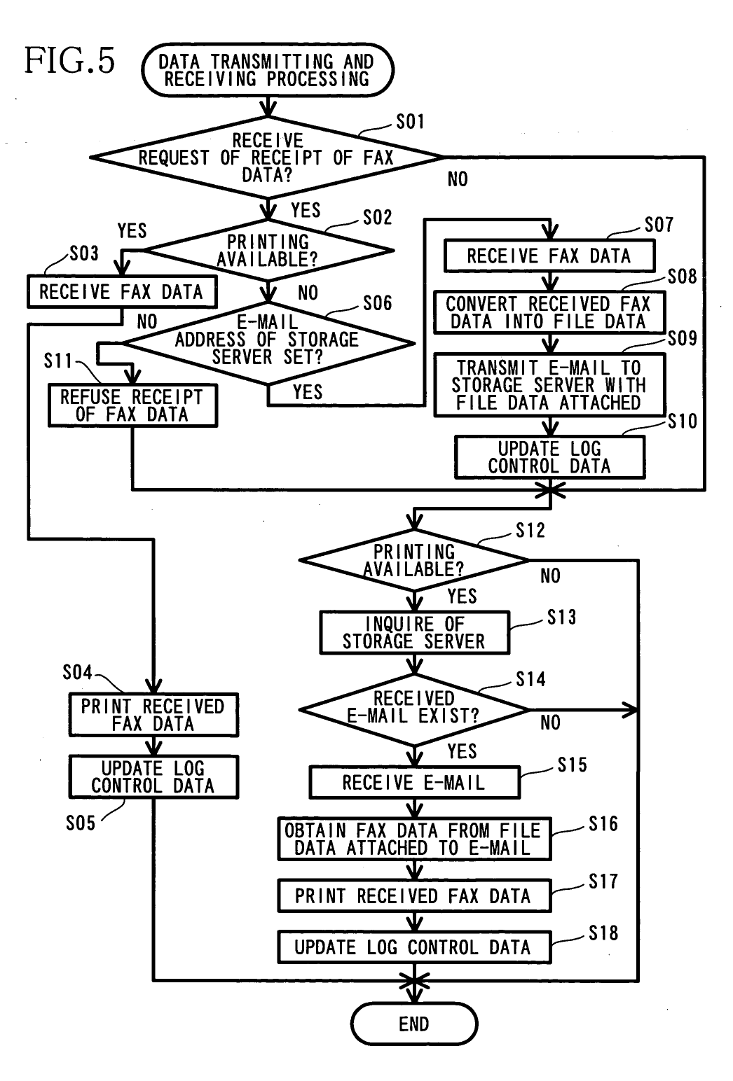

Data transmitting and receiving processing to be executed by the CPU 18 will be described with reference to FIG. 5. This processing is repeatedly performed while the facsimile machine 1 is turned or powered on.

When the processing starts, the CPU 18 determines whether the network control unit 56 and the modem 55 have received a request of receipt of facsimile data at S01. When the network control unit 56 and the modem 55 have received the request (S01 YES), flow moves to S02. When the network control unit 56 and the modem 55 have not received a request of receipt of facsimile data (S01:NO), flow moves to S12.

At S02, the CPU 18 determines whether the printing unit 17 is available to perform a printing operation (i.e. whether the printing unit 17 is in a printable state). The determination is made by the state of the printing unit 17, that is, by the presence or absence of a problem in the printing unit 17, such as a running out of recording sheets or toner, or a breakdown. Thus, when the printing unit 17 does not have any problems, it is determined that the printing unit 17 is available. When the printing unit 17 has at least one of the above problems, it is determined that the printing unit 17 is not available.

When the recording unit 17 is in the printable state (S02:YES), at S03, the facsimile machine 1 receives facsimile (FAX) data by way of the network control unit 56 and the modem 55 and then stores the received facsimile data in a predetermined storage area (the transmitting/receiving data storage portion 52b) of the RAM 52. Then, at S04, the decoder 54 decodes the facsimile data stored in the transmitting/receiving data storage portion 52b into image data for printing (bitmap data). After that, the CPU 18 allows the recording unit 17 to perform a printing operation by transferring the decoded facsimile data to the recording unit 17. Then, at S05, the printing of the facsimile data is recorded in the log control data storage portion 52e, and thus, the data transmitting and receiving processing is finished.

When the recording unit 17 is not available (S02:NO), at S06, the CPU 18 determines whether an e-mail address of a target storage server has been set in the save location data storage portion 52d. When the e-mail address has been set in the save location data storage portion 52d (S6:YES), flow moves to S07. At S07, the facsimile machine 1 receives facsimile data by the network control unit 56 and the modem 55 and stores the received facsimile data in the predetermined storage area (the transmitting and receiving data storage portion 52d) of the RAM 52.

After that, at S08, the CPU 18 converts the facsimile data stored in the transmitting/receiving data storage portion 52b into image data in an electronic mail format transmittable as an e-mail. Then, at S09, the CPU 18 transmits an e-mail with the converted facsimile data, that is file data, attached, to the Internet server 3 which is assigned in the save location data storage portion 52d. At S10, the transmission of the facsimile data is recorded in the log control data storage portion 52e, and then flow moves to S12.

At S06, when the e-mail address of the storage server has not been set (S06:NO), the facsimile machine 1 refuses receipt of the facsimile data at S11 and flow moves to S12.

At S12, the CPU 18 determines whether the recording unit 17 is available to perform the printing operation. When the recording unit 17 is in the printable state (S12:YES), flow moves to S13 to make an inquiry of the Internet server 3 whether an e-mail is stored in the Internet server 3, by accessing the Internet server 3 through the Internet 200, and to receive a response from the Internet server 3 with respect to the inquiry. Then, at S14, the CPU 18 determines the response whether an e-mail is stored in the Internet server 3. When the Internet server 3 stores an e-mail (S14:YES), flow moves to S15. At S15, the facsimile machine 1 receives the e-mail from the Internet server 3. In this context “an e-mail” is defined as an unread e-mail, i.e., one that has not yet been opened by a request from facsimile machine 1.

Then, at S16, the CPU 18 converts the file data attached to the e-mail into image data in a facsimile format (the reverse format) and then stores the converted facsimile data in the predetermined storage area (the transmitting/receiving data storage portion 52b) of the RAM 52.

After that, at S17, the decoder 54 decodes the facsimile data stored in the transmitting/receiving data storage portion 52b into image data for printing (bitmap data). Then, the CPU18 allows the recording unit 17 to perform the printing operation by transferring the decoded facsimile data to the recording unit 17: Next, at SI 8, the printing of the facsimile data is recorded in the log control data storage portion 52e and the data transmitting and receiving processing is finished.

At S12, when the recording unit 17 is not available (S12:NO), and at S14, when the Internet server 3 stores no new e-mail therein (S114:NO), and the data transmitting and receiving processing is finished.

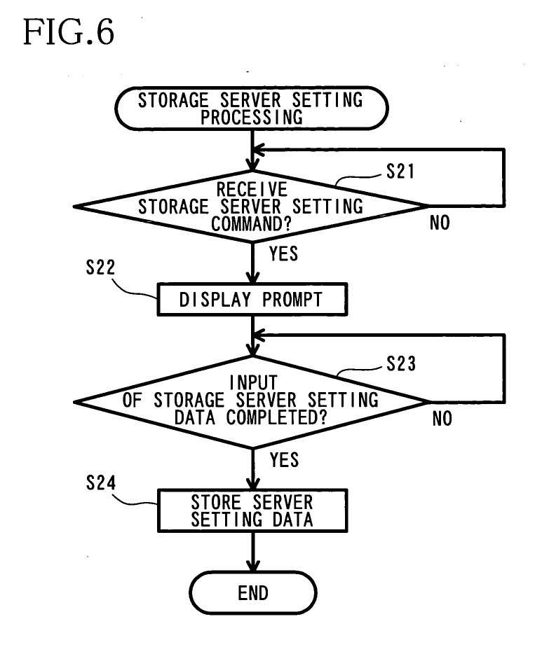

Next, storage server setting processing to be executed by the CPU 18 will be described with reference to FIG. 6. This processing is repeatedly performed while the power of the facsimile machine 1 is on.

When this processing starts, at S21, the CPU 18 waits until receiving a storage server setting command from the operating panel 12. When the CPU 18 determines the receipt of the storage server setting command (S21:YES), the CPU 18 displays a prompt on the LCD 124 to allow the user to input storage server setting data, such as a mail server address, an e-mail address of the mail server, a user ID and a password, at S22.

After that, at S23, the CPU 18 waits until receiving an input completion signal indicating the completion of the input of the storage server setting data, from the operating panel 12. Upon receipt of the input completion signal, the CPU 18 determines that the input of the storage server setting data is finished (S23:YES) and flow moves to S24. At S24, the CPU 18 stores the data indicating the storage server setting data inputted by the external operation of the user through the operating panel 12, in the save location data storage portion 52d. Then, the storage server setting processing is finished.

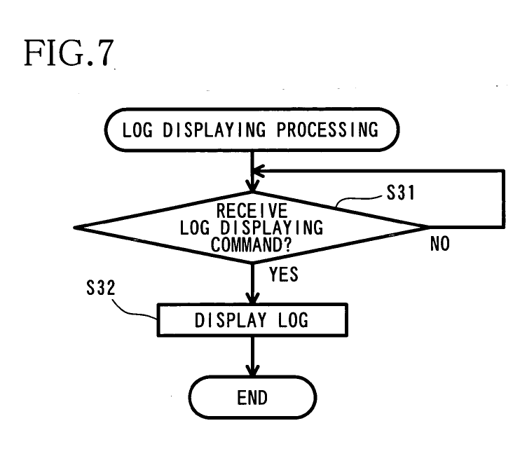

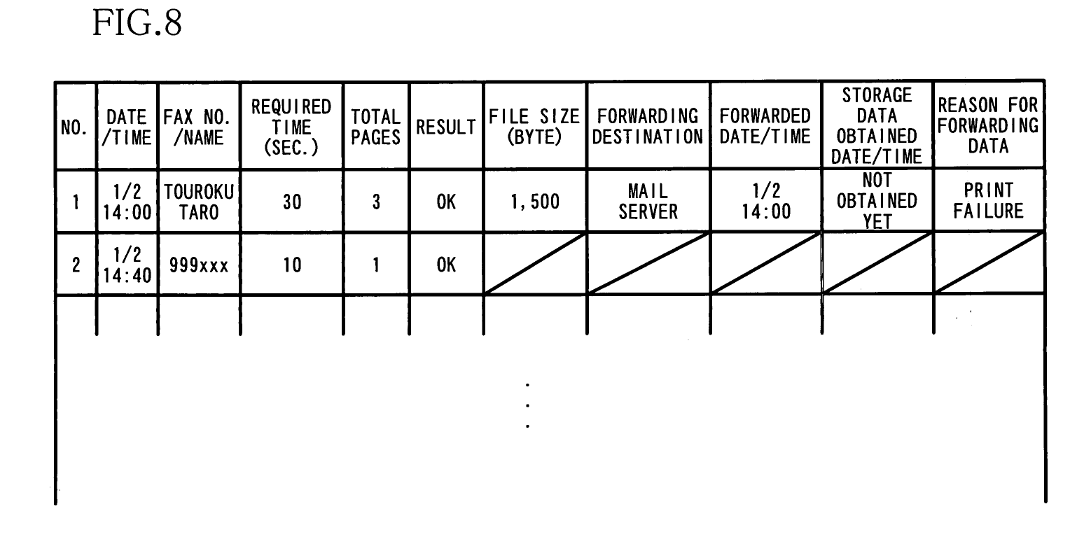

Next, log displaying processing to be executed by the CPU 18 will be described with reference to FIG. 7. This processing is repeatedly performed while the facsimile machine 1 is turned on. When this processing starts, at S31, the CPU 18 waits until receiving a log displaying command. When the CPU 18 determines the receipt of the log displaying command (S31:YES), flow moves to S32. At S32, the CPU 18 reads log control data from the log control data storage portion 52e and displays the read log control data on the LCD 124. Then, the log displaying processing is finished. An example of the log control data to be displayed is shown in FIG. 8. As shown in FIG. 8, the log control data is shown in tabular list form.

Items, “no.”, “date/time”, “fax no./name”, “required time”, “total pages”, and “communication result” are control record data of normal facsimile communications.

“File size” indicates a volume of forwarded facsimile data. “Forwarding destination” indicates the location to which facsimile data is forwarded when a printing failure occurs in the facsimile machine 1. “Forwarded date/time” indicates the date and time at which facsimile data is forwarded to the forwarding destination. “Storage data obtained date/time” indicates the date and time at which the facsimile machine 1 obtains data from the forwarding destination and prints the facsimile data. “Reason for forwarding data” indicates a reason why facsimile data was forwarded to the forwarding destination.

The log control data of item no. 1 shows a case in which facsimile data has been forwarded to a mail server due to the occurrence of a printing failure when the facsimile machine 1 received the facsimile data. The log control data of item no. 2 shows a case in which facsimile data was printed because the recording unit 17 was available to perform a printing operation when the facsimile machine 1 received the facsimile data.

In the log control data of no. 1, the date and time are indicated in the “forwarded date/time” column and “not obtained yet” is indicated in the “storage data obtained date/time” column, which means that facsimile data is still stored in the storage server and has not yet been obtained by the facsimile machine 1. The user can recognize the state of the facsimile data by viewing the list of the log control data. In addition, because the forwarding destination is indicated in the list, the user can confirm the save location of the received facsimile data.

In the first embodiment, the modem 55 and the network control unit 56 function as a first communication unit, the LAN interface 57 functions as a second communication unit, and the input and output interface 59 functions as a third communication unit. The operating panel 12 functions as a setting data inputting device of the invention, and the recording unit 17 functions as an image forming device of the invention.

The CPU 18, that performs the steps S01 to S04 and S06 to S09 of the data transmitting and receiving processing of FIG. 5, functions as a communication control device of the invention, and the save location data storage portion 52d functions as a storage device of the invention. A device including the modem 55, the network control unit 56, the LAN interface 57, the input and output interface 59, and the CPU 18 (as the communication control unit) functions as a data transmitting and receiving device of the invention.

According to the facsimile machine 1 of the first embodiment, when facsimile data is received by the modem 55 and network control unit 56 via the PSTN 100, the received facsimile data is transferred to the recoding unit 17 via the input and output interface 59 if the recording unit 17, connected to the input and output interface 59, is available to perform the printing operation. When the recording unit 17 is in the unprintable state, the facsimile data received by the modem 55 and the network control unit 56 is stored in the Internet server 3 on the Internet 200.

Accordingly, even though the recording unit 17 is in the unprintable state, that is, the recording unit 17 cannot print the facsimile data, the modem 55 and the network control unit 56 can receive the facsimile data via the PSTN 200.

When the recording unit 17 can perform the printing operation, the modem 55 and the network control unit 56 receive the facsimile data from the Internet server 3 via the LAN interface 57 and transfer the received facsimile data to the recording unit 17 via the input and output interface 59. Thus, when the recording unit 17 returns to, i.e., is in, the printable state, the user can confirm the facsimile data by printing the data.

In addition, by performing the storage server setting processing, a mail server address and an e-mail address of the mail server specifying the Internet server 3 can be set. Thus, the destination to forward the facsimile data can be changed depending on the user's desire.

Further, the facsimile machine 1 can store a user ID and a password, for logging on to the Internet server 3, in the RAM 52 (the save location data storage portion 52d). By using the user ID and the password, safety in the transmission and receipt of facsimile data to and from the Internet server 3 can be improved and the facsimile data can be stored safely in the Internet server 3.

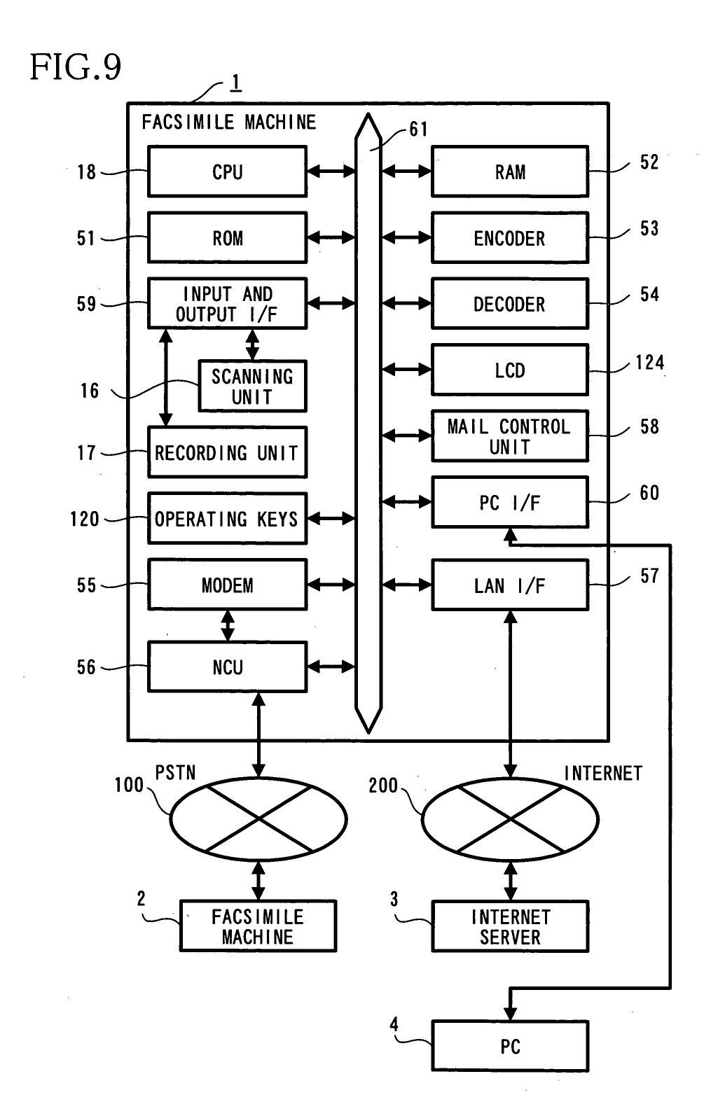

A second embodiment of the invention will be described with reference to FIGS. 9 to 11. The appearance and internal structure of the facsimile machine 1 of the second embodiment are basically the same as those of the facsimile machine 1 of the first embodiment. However, there are differences between the facsimile machine 1 of the first embodiment and the facsimile machine 1 of the second embodiment in the electrical configuration and in the data transmitting and receiving processing. Accordingly, explanations for the same parts and some processing will be omitted, or minimized, and the different parts and processing will be described in detail.

First, the electrical configuration of the facsimile machine 1 of the second embodiment will be described with reference to FIG. 9. The facsimile machine 1 includes a CPU 18, a ROM 51, a RAM 52, a scanning unit 16, an encoder 53, a recording unit 17, a decoder 54, operating keys 120, an LCD 124, a modem 55, a mail control unit 58, an input and output interface (I/F) 59, and a PC interface (I/F) 60, which are connected with each other by a bus 61.

Because the elements, other than the PC interface 60, are the same as those provided in the facsimile machine 1 of the first embodiment, explanations for those same elements will be omitted.

The PC interface 60 is used to allow the facsimile machine 1 to connect to a personal computer (PC) 4 via, for example, a parallel interface. The PC interface 60 permits the facsimile machine 1 to transmit and receive data to and from the PC 4.

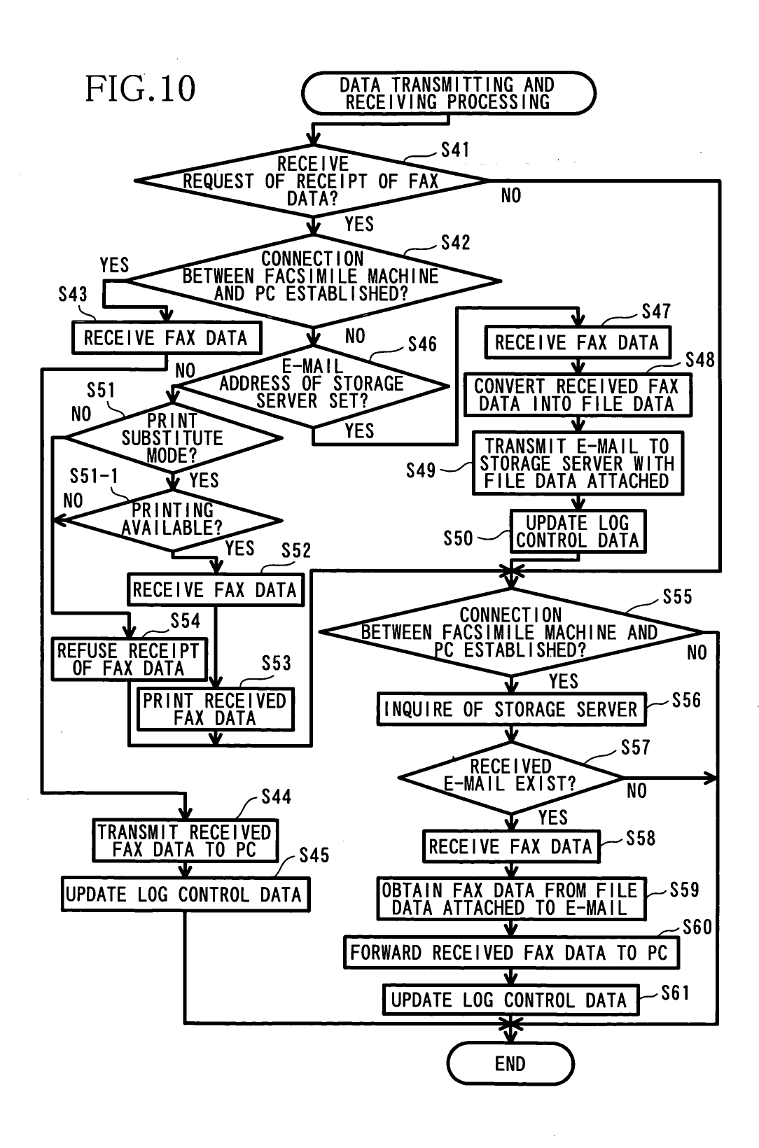

Data transmitting and receiving processing to be executed by the CPU 18 of the second embodiment will be described with reference to FIG. 10. This processing is repeatedly performed while the power of the facsimile machine 1 is on.

When this processing starts, the CPU 18 determines whether the network control unit 56 and the modem 55 have received a request of receipt of facsimile data at S41. When the network control unit 56 and the modem 55 have received the request (S41:YES), flow moves to S42. When the network control unit 56 and the modem 55 have not received the request (S41:NO), flow moves to S55.

At S42, the CPU 18 determines whether a connection between the facsimile machine 1 and the PC 4 is established via the PC interface 60. This judgment is made on the basis of the CPU 18 receiving a signal response to a connection check signal, which was transmitted by the CPU 18 to the PC 4 via the PC interface 60, within a predetermined time period (e.g. 10 seconds). That is, when the PC 4 is turned off (power off) or when the facsimile machine 1 and the PC 4 are not physically connected with each other via a signal cable, a response signal is not inputted into the CPU 18.

When the connection is established (S42:YES), flow moves to S43. At S43, the facsimile machine 1 receives facsimile data by the network control unit 56 and the modem 55 and stores the received facsimile data into a predetermined storage area (the transmitting/receiving data storage portion 52b) of the RAM 52. Then, flow moves to S44 to transmit the facsimile data stored in the transmitting/receiving data storage portion 52b to the PC 4 via the PC interface 60. After that, at S45, the transmission of the facsimile data to the PC 4 is recorded in the log control data storage portion 52e. Then, the data transmitting and receiving processing is finished.

When the connection between the facsimile machine 1 and the PC 4 is not established (S42:NO), at S46, the CPU 18 determines whether an e-mail address of a forwarding storage server has been set in the save location data storage portion 52d. When the e-mail address has been set (S46:YES), at S47, the facsimile machine 1 receives facsimile data by the network control unit 56 and the modem 55 and stores the received facsimile data in the predetermined storage area (the transmitting/receiving data storage portion 52b) of the RAM 52.

Then, at S48, the facsimile data stored in the transmitting/receiving data storage portion 52b is converted into image data in an electronic mail format transmittable as an e-mail by the mail control unit 58. After that, at S49, the converted facsimile data, that is file data, is attached to an e-mail and the e-mail is transmitted to the Internet server 3 specified by the e-mail address stored in the save location data storage portion 52d. Then, at S50, the transmission of the facsimile data is recorded in the log control data storage portion 52e, and flow moves to S55.

At S46, when the e-mail address of the target storage server has not been set (S46:NO), the CPU 18 determines whether the facsimile machine 1 has been set to a print substitute mode, at S51. When the facsimile machine 1 has been set to the print substitute mode (S51:YES), at S51-1, the CPU 18 determines that the recording unit 17 of the facsimile machine 1 is available to perform a printing operation (whether the recording unit 17 is in a printable state). When the recording unit 17 can perform the printing operation (S51-1:YES), flow moves to S52. At S52, the facsimile machine 1 receives facsimile data by the network control unit 56 and the modem 55 and stores the received facsimile data into the predetermined storage area (the transmitting/receiving data storage portion 52b). Then, at S53, the facsimile data stored in the transmitting/receiving data storage portion 52b is decoded into image data for printing (bitmap data) by the decoder 54. The CPU 18 transmits the decoded facsimile data to the recording unit 17 to allow the recording unit 17 to print the facsimile data. After that, flow moves to S55.

When the facsimile machine 1 has not been in the print substitute mode (S51:NO) or when the recording unit 17 is not in the printable state (S 51-1:NO), the facsimile machine 1 refuses receipt of the facsimile data at S54 and flow moves to S55.

At S55, the CPU 18 determines whether the connection between the facsimile machine 1 and the PC 4 is established via the PC interface 60. When the connection is established (S55:YES), flow moves to S56 to make an inquiry of the Internet server 3 whether a newly received e-mail is stored in the Internet server 3, by accessing the Internet server 3 through the Internet 200, and to receive a response from the Internet server 3 with respect to the inquiry. Then, at S57, the CPU 18 determines whether an e-mail is stored in the Internet server 3. When the Internet server 3 stores an e-mail (S57:YES), flow moves to S58. At S58, the facsimile machine 1 receives the e-mail from the Internet server 3.

Then, at S59, the CPU 18 converts the file data attached to the e-mail into image data in a facsimile format and then stores the converted facsimile data in the predetermined storage area (the transmitting/receiving data storage portion 52b) of the RAM 52.

After that, at S60, the facsimile machine 1 transmits the facsimile data, stored in the transmitting/receiving data storage portion 52b, to the PC 4 via the PC interface 60. At S61, the transmission of the facsimile data to the PC 4 is recorded in the log control data storage portion 52e. Then, the data transmitting and receiving processing is finished.

At S55, when the connection is not established (S55:NO), and at S57, when there is no e-mail in the Internet server 3 (S57:NO), the data transmitting and receiving processing is finished.

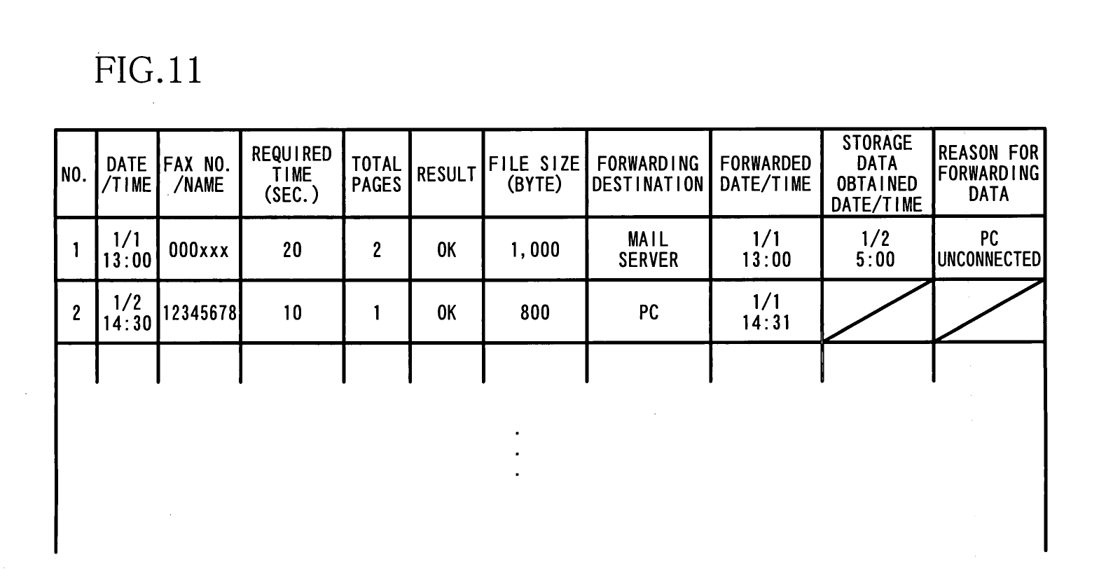

An example of the log control data for display is shown in FIG. 11. The log control data is shown in tabular list form. Items, “no.”, “date/time”, “fax no./name”, “required time”, “total pages”, and “communication result” are control record data for normal facsimile communications.

“File size” indicates a volume of forwarded facsimile data. “Forwarding destination” indicates a location to which the facsimile data is forwarded when the connection between the facsimile machine 1 and the PC 4 is not established. “Forwarded date/time” indicates the date and time at which facsimile data is forwarded to the forwarding destination. “Storage data obtained date/time” indicates the date and time at which the facsimile machine 1 obtained facsimile data from the forwarding destination and transfers the facsimile data to the PC 4. “Reason for forwarding data” indicates a reason why facsimile data is forwarded to the forwarding destination.

The log control data of item no. 1 shows a case in which facsimile data has been forwarded to a mail server because the connection between the facsimile machine 1 and the PC 4 was not established when the facsimile machine 1 received the facsimile data. The log control data of item no.2 shows a case in which facsimile data has been transmitted to the PC 4 because the connection between the facsimile machine 1 and the PC 4 is established when the facsimile machine 1 received the facsimile data.

In the second embodiment, the modem 55 and the network control unit 56 function as a first communication device of the invention, the LAN interface 57 functions as a second communication device of the invention, and the PC interface 60 functions as a third communication device. The PC 4 functions as a data processing device of the invention.

The CPU 18 that performs the steps of S41 to S43, S46 and S47 of the data transmitting and receiving processing of FIG. 10 functions as a communication control device of the invention.

According to the facsimile machine 1 of the second embodiment, the facsimile machine 1 transfers facsimile data to the PC 4 via the PC interface 60 if the connection is established between the facsimile machine 1 and the PC 4 via the PC interface 60 when the modem 55 and the network control unit 56 receive the facsimile data via the PSTN 100. In a case where the connection is not established, the facsimile machine 1 stores the facsimile data, received by the modem 55 and the network control unit 56, in the Internet server 3 on the Internet 200 through the LAN interface 57. Accordingly, even when the connection is not established, the modem 55 and the network control unit 56 can receive facsimile data through the PSTN 100.

When the connection between the facsimile machine 1 and the PC 4 is established via the PC interface 60, the facsimile machine 1 obtains the facsimile data from the Internet server 3 via the LAN interface 57 and further transfers the facsimile data to the PC 4 via the PC interface 60. Accordingly, when the PC 4 becomes able to receive facsimile data from the facsimile machine 1, the user can view the facsimile data on the display of the PC 4. The PC 4 can store, display, and process the received facsimile data.

While the invention has been described in detail with reference to specific embodiments thereof, it would be apparent to those skilled in the art that various changes, arrangements and modifications may be applied therein without departing from the spirit and scope of the invention.

In the above-described embodiments, the examples that an image is formed by a monochrome laser printing technique have been described. However, for example, the image forming device can be an ink-jet type or a thermal transfer type. Further, the image forming device may form an image in color.

In the above-described embodiments, the data transmitting and receiving processing of FIGS. 3 and 10 is executed by the CPU 18 provided in the facsimile machine 1. However, the data transmitting and receiving processing may be executed by a separated computer system connected to the facsimile machine 1 by a signal transmission line (cable/wire or wireless). A transmitting and receiving program allows a computer to function as each unit of the data transmitting and receiving device.

A computer system controlled by the transmitting and receiving program makes up a part of the data transmitting and receiving device. The transmitting and receiving program is provided to the data transmitting and receiving device itself, the facsimile machine 1, and users of the data transmitting and receiving device and the facsimile machine 1 via, for example, a recording medium, such as an floppy disk or a CD-ROM, or a communication network, such as the Internet.

For the computer system operating the data transmitting and receiving device, a computer system installed in the data transmitting and receiving device or the facsimile machine 1, or a computer system communicably connected to the data transmitting and receiving device or the facsimile machine 1 via a communication path (wireless or cable/wire) can be used, for example.

What is claimed is:

1. A data transmitting and receiving device, comprising:
a first communication device that performs data communication via a public switched telephone network;
a second communication device that performs data communication via the Internet;
a third communication device that performs data communication with a processing device that processes facsimile data; and
a communication control device that determines whether the processing device connected to the third communication device can receive facsimile data when the first communication device receives the facsimile data via the public switched telephone network, wherein the communication control device transfers the facsimile data received by the first communication device to the processing device through the third communication device when the processing device can receive the facsimile data, and the communication control device transfers the facsimile data received by the first communication device to a predetermined server on the Internet through the second communication device when the processing device cannot receive the facsimile data.

2. The data transmitting and receiving device according to claim 1, wherein the communication control device determines whether the processing device can receive facsimile data when the first communication device has not received facsimile data via the public switched telephone network, wherein the communication control device receives the facsimile data from the server through the second communication device and further transfers the facsimile data to the processing device through the third communication device when the processing device can receive the facsimile data.

3. The data transmitting and receiving device according to claim 1, wherein the processing device includes a data processing device that stores, displays and processes the received facsimile data.

4. The data transmitting and receiving device according to claim 1, wherein the server is specified by a mail server address and an e-mail address, and comprising:
a setting data inputting device that is used by a user in order to input the mail server address and the e-mail address as setting data; and
a storage device that stores the setting data of the specified server as data of the server to which the facsimile data is to be transferred.

5. The data transmitting and receiving device according to claim 4, wherein an input of a user ID and a password is required to log on to the server, and the setting data inputting device is used by the user in order to input the user ID and the password as setting data in addition to the setting data of the mail server address and the e-mail address, and the storage device stores the setting data as the user ID and the password for logging on to the server when the setting data of the user ID and the password is inputted by the setting data inputting device.

6. A facsimile machine comprising a data transmitting and receiving device, the data transmitting and receiving device comprising:
a first communication device that performs data communication via a public switched telephone network;
a second communication device that performs data communication via the Internet;
a third communication device that performs data communication with a processing device that processes facsimile data; and
a communication control device that determines whether the processing device connected to the third communication device can receive facsimile data when the first communication device receives the facsimile data via the public switched telephone network, wherein the communication control device transfers the facsimile data received by the first communication device to the processing device through the third communication device when the processing device can receive the facsimile data, and the communication control device transfers the facsimile data received by the first communication device to a predetermined server on the Internet through the second communication device when the processing device cannot receive the facsimile data.

7. A data transmitting and receiving program that allows a computer to function as each device of a data transmitting and receiving device, the data transmitting and receiving device comprising:
a first communication device that performs data communication via a public switched telephone network;
a second communication device that performs data communication via the Internet;
a third communication device that performs data communication with a processing device that processes facsimile data; and
a communication control device that determines whether the processing device connected to the third communication device can receive facsimile data when the first communication device receives the facsimile data via the public switched telephone network, wherein the communication control device transfers the facsimile data received by the first communication device to the processing device through the third communication device when the processing device can receive the facsimile data, and the communication control device transfers the facsimile data received by the first communication device to a predetermined server on the Internet through the second communication device when the processing device cannot receive the facsimile data.

8. A data transmitting and receiving device, comprising:
a first communication device that performs data communication via a public switched telephone network;
a second communication device that performs data communication via the Internet;
a third communication device that performs data communication with an image forming device that processes facsimile data; and
a communication control device that determines whether the image forming device connected to the third communication device can receive facsimile data when the first communication device receives the facsimile data via the public switched telephone network, wherein the communication control device transfers the facsimile data received by the first communication device to the image forming device through the third communication device when the image forming device can receive the facsimile data, and the communication control device transfers the facsimile data received by the first communication device to a predetermined server on the Internet through the second communication device when the image forming device cannot receive the facsimile data.

9. The data transmitting and receiving device according to claim 8, wherein the communication control device determines whether the image forming device can receive facsimile data when the first communication device has not received facsimile data via the public switched telephone network, wherein the communication control device receives the facsimile data from the server through the second communication device and further transfers the facsimile data to the image forming device through the third communication device when the image forming device can receive the facsimile data.

10. The data transmitting and receiving device according to claim 8, wherein the image forming device includes a recording unit that forms an image based on the received facsimile data.

11. The data transmitting and receiving device according to claim 8, wherein the server is specified by a mail server address and an e-mail address, and comprising:
a setting data inputting device that is used by a user in order to input the mail server address and the e-mail address as setting data; and
a storage device that stores the setting data of the specified server as data of the server to which the facsimile data is to be transferred.

12. The data transmitting and receiving device according to claim 11, wherein an input of a user ID and a password is required to log on to the server, and the setting data inputting device is used by the user in order to input the user ID and the password as setting data in addition to the setting data of the mail server address and the e-mail address, and the storage device stores the setting data as the user ID and the password for logging on to the server when the setting data of user ID and the password is inputted by the setting data inputting device.

13. A transmission apparatus, comprising:
a first communication unit that communicates with remote facsimile machines;
a second communication unit that communicates with at least one internet server providing an e-mail service;
a recording unit that prints material received from a remote facsimile machine and the at least one internet server;
a determination device that determines an operational status of the recording unit; and
a communication control unit, which allows receipt of a facsimile message through the first communication unit when the determination device determines the recording unit is operating properly and, when the recording device is not operating properly, allows receipt of the facsimile message through the first communication unit and then forwards the facsimile message through the second communication unit to a designated internet server.

14. The transmission apparatus according to claim 13, further comprising a storage device that stores, at least, incoming facsimile or e-mail messages received through the respective first or second communication units and communication data for connecting with the e-mail service.

15. The transmission apparatus, according to claim 13, further comprising a third communication unit that provides facsimile messages received through the first communication unit and e-mail messages received through the second communication unit to the recording unit.

16. The transmission apparatus according to claim 13, further comprising a conversion unit for converting a facsimile message to an e-mail message and vice versa.

17. The transmission apparatus according to claim 16, further comprising a third communication unit that provides facsimile messages received through the first communication unit and e-mail messages received through the second communication unit to the recording unit.

18. The transmission apparatus according to claim 14, further comprising an input device that permits inputting the communication data.

19. The transmission apparatus according to claim 13, further comprising a third communication unit that communicates to a remote computer, the communication control unit capable of forwarding facsimile messages to the remote computer through the third communication device.

20. The transmission apparatus according to claim 19, further comprising a fourth communication unit that provides facsimile messages received through the first communication unit, e-mail messages received through the second communication unit, and data received through the third communication unit to the recording unit.

21. A method of receiving facsimile messages, comprising:
receiving request for receipt of a facsimile message;
determining availability of a printing unit;
determining availability of an internet server;
accepting a facsimile message when at lest one of the printing unit and the internet server is available;
forwarding the facsimile message to the internet server when the printing unit is not available; and
creating a log of message status.

22. The method according to claim 21, further comprising:
checking the internet server for messages when the printing unit is available; and
obtaining each message from the internet server when the printing unit is available.

23. The method according to claim 22, further comprising:
converting facsimile formatted data to e-mail formatted data and vice-versa as necessary; and
printing the data when the printing unit is available.

24. The method according to claim 23, further comprising:
determining availability of a remote computer;
accepting the facsimile message when neither the printing unit or internet server is available if the remote computer is available; and
forwarding the facsimile message to the remote computer when neither the printing unit or internet server are available.
